(19) United States
(12) Patent Application Publication
(10) Pub. No.: US 2008/0191066 A1
(43) Pub. Date: Aug. 14, 2008

(54) WATER CUTTING ASSEMBLY AND NOZZLE NUT

(76) Inventors: Ted Jernigan, Olympia, WA (US); Halan Arnold, Aberdeen, WA (US); John Nguyen, Lacey, WA (US)

Correspondence Address: MICHAEL BEST & FRIEDRICH LLP, 100 E WISCONSIN AVENUE, Suite 3300, MILWAUKEE, WI, 53202, US

(21) Appl. No.: 11/674,305

(22) Filed: Feb. 13, 2007

(51) Int. Cl. B05B 15/08

(52) U.S. Cl. 239/587.1; 239/600

(57) ABSTRACT

A water cutting assembly with an increased stream cohesiveness to improve the efficiency of water cutting operations. The water cutting assembly includes a nozzle, a nozzle nut, and an orifice assembly that defines a collimating chamber to reduce turbulence of the water before it exits an orifice passage in the orifice assembly.

### BACKGROUND OF THE INVENTION

This present invention is directed to a water cutting assembly and nozzle nut that allows a more cohesive high velocity water stream for cutting of materials.

High pressure water assemblies 100 typically include a nozzle 120 and a retainer 102 secured to the nozzle by a nut 108 (FIG. 1). The retainer 102 forms a water tight seal with the nozzle 120 and includes an orifice member 106 sealed to the retainer by an O-ring 104. The orifice member 106 is typically formed from a sapphire or ruby material. The retainer 102 also includes an elongated passage extending away from the orifice 106. The retainer 102 and orifice member 106 are designed to be replaceable so that when the orifice member 106 wears out and the stream loses efficiency or cohesiveness or the seals 104 around the orifice member 106 wear out, the retainer 102 including orifice member 106 may be discarded and replaced. However, replacement of the retainer 102 with a new retainer including a new orifice member is difficult and reduces valuable operational time. More specifically, when the orifice member is replaced valuable time is spent aligning and realigning the position of the retainer as well as recalibrating the apparatus so that the water stream will contact the work piece precisely.

Manufacturers continue to strive to create more cohesive water streams and therefore faster and more accurate and precise cuts. Therefore, with any water cutting assembly, a cohesive and narrow water stream is desired to create a water cutting apparatus that is more efficient, precise and accurate. Most improvements to the water stream cohesiveness relate to the orifice passage.

### SUMMARY OF THE INVENTION

In view of the above, the present invention is directed to an assembly for a water cutting apparatus that includes an improved nozzle assembly that improves the cohesiveness of the exiting water stream. A more cohesive water stream at high pressure allows for more efficient operation and faster cutting times.

The present invention includes an end assembly for a water cutting apparatus comprising a nozzle, a nut coupled to the nozzle, and a collimating chamber defined between the nozzle and the nut. The collimating chamber has a volume and a portion of the volume is formed by each of the nut and the nozzle.

The nozzle may include a first end and an opposing second end, with an elongated passageway extending between the first and second ends. The elongated passageway includes an expanded area portion. The nut may include an orifice assembly, so that the nut, nozzle and the orifice assembly define a collimating chamber. The orifice assembly includes a retainer having an inner profiled surface extending from the nut to the orifice member with a decreasing diameter. The expanded area portion, in combination with an inner profiled surface cooperate to create an enlarged collimating chamber.

A nut having an orifice member for use with a water cutting apparatus. The nut includes a cavity having a threaded area, a sealing surface, a profiled surface and orifice cavity. The sealing surface is located between said threaded area and said profiled surface. An orifice assembly is retained within the orifice cavity. The orifice assembly includes an orifice and a retainer having an inner retainer profile.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a partial sectional view of a prior art water cutting assembly;

FIG. 2 is a partial sectional view of a first exemplary water cutting assembly;

FIG. 3 is a partial sectional view of a second exemplary water cutting assembly;

FIG. 4 is a partial sectional view of a third exemplary water cutting assembly;

FIG. 5 is a partial sectional view of a fourth exemplary water cutting assembly;

FIG. 6 is a partial sectional view of a fifth exemplary water cutting assembly;

FIG. 7 is a partial sectional view of a sixth exemplary water cutting assembly;

FIG. 8 is a partial sectional view of a seventh exemplary water cutting assembly;

FIG. 9 is a partial sectional view of a eighth exemplary water cutting assembly; and

FIG. 10 is a partial sectional view of a ninth exemplary water cutting assembly.

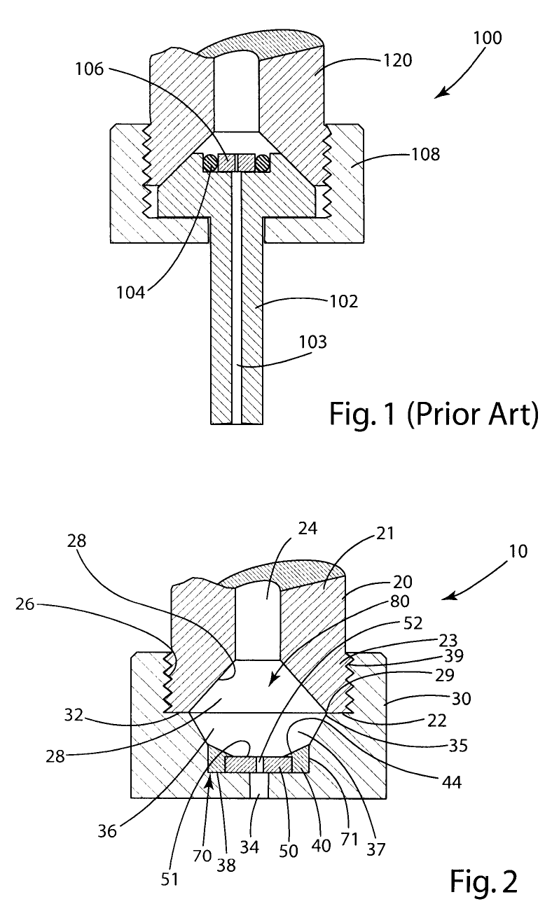

### DETAILED DESCRIPTION OF THE PREFERRED EMBODIMENT

As illustrated in FIG. 2 the present invention is directed to a water cutting assembly 10 having a nozzle body 20, a nozzle nut 22, and an orifice assembly 70. The nozzle 20 generally includes threads 26 to which the nozzle nut 30 is secured with a threaded portion 39. To perform water cutting operations, high pressure water is provided through an inlet passage 24 on the nozzle 20 to an expanded region portion, generally referred to in this application as a collimating chamber 80. The water then passes through a restriction such as the illustrated orifice passage 52 in the orifice member 50. By releasing the water through an opening the size of the orifice passage 52 a very high velocity water stream is created that is capable of cutting materials such as steel or aluminum.

The nozzle 20 generally includes an elongated body 21 which defines the inlet passage 24. At a first end, not illustrated, the nozzle 20 is connected to an apparatus that provides high pressure water to the inlet passage 24. Many prior art nozzles have a collimating chamber at the first end, and the present invention may also have a variety of configurations at the first end, including a collimating chamber. The apparatus or assembly to which the nozzle 20 is coupled may be a robotic arm capable of movement. At the second end 23, the nozzle 20 includes threads 26 or other coupling means and an inner wall or a first profiled surface 28 that defines an expanded region 29 which forms at least a portion of the collimating chamber 80. The nozzle 20 also includes a seal surface or a first engagement surface 22 which allows the nozzle nut 30 to be coupled to the nozzle 20 with a water tight seal. The first engagement surface 22 meets the first profiled surface 28 at an inner nozzle edge 29. While the first engagement surface 22 is illustrated as being in a plane perpendicular to the axis of the inlet passage 24, other geometric configurations may be used such as a beveled surface, so long as the nozzle nut 30 is capable of being sealed to the nozzle 20 to withstand the high pressures within the inlet passage 24 and collimating chamber 80.

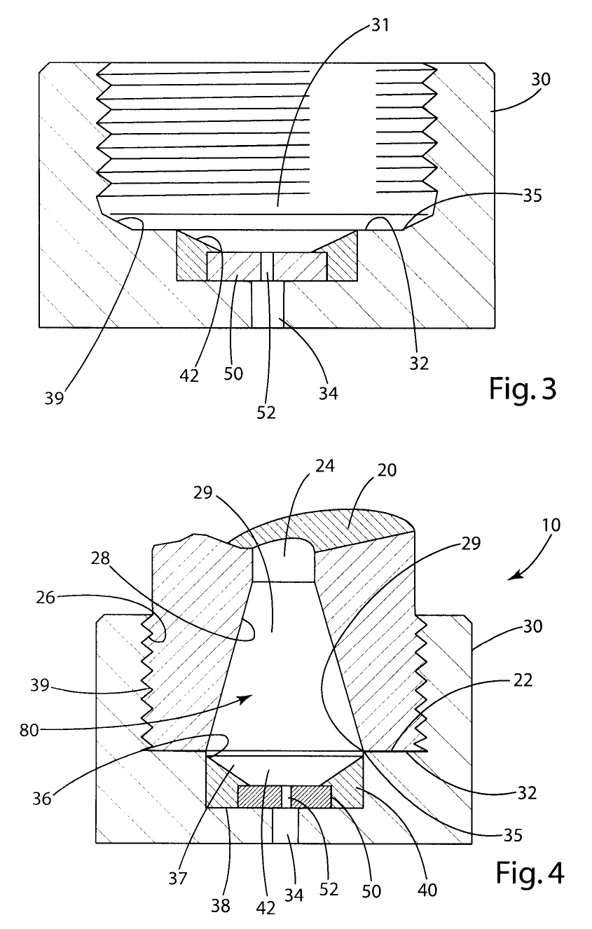

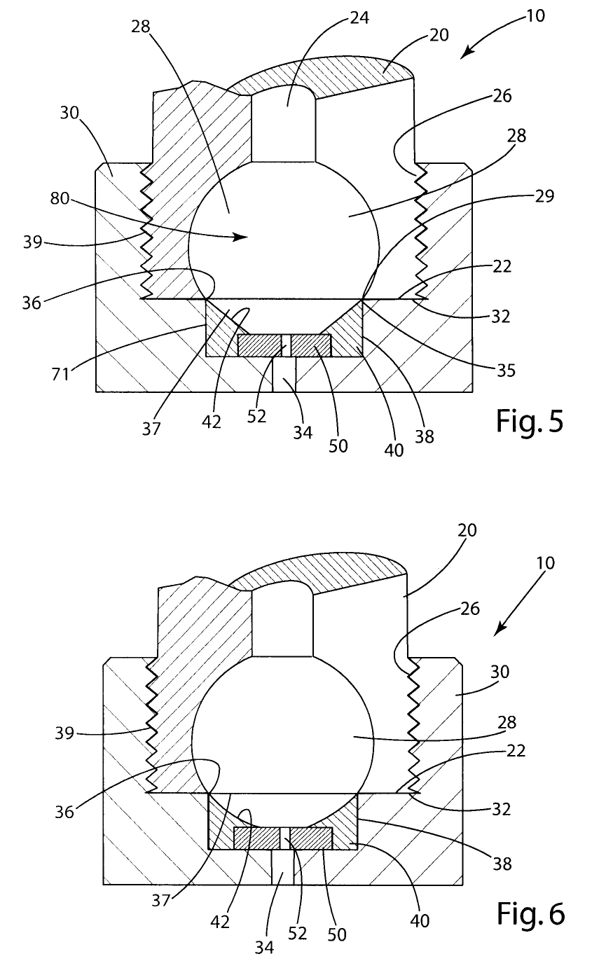

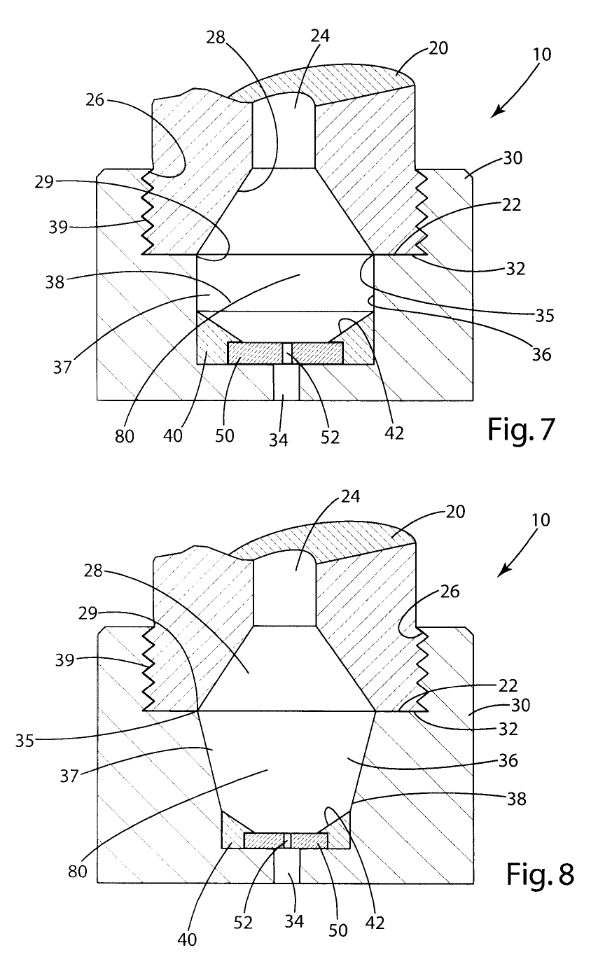

The nozzle nut 30 defines a cavity 31 having a threaded portion 39, a second engagement or seal surface 32, an inner wall or second profiled surface 36, an orifice cavity 38, and an outlet passage 34. The threaded portion 39 allows the nozzle nut 30 to be threaded onto the nozzle 20 although other means of connection may be used. The second engagement surface 32 creates a water tight seal with the first engagement surface when the nozzle nut 30 is coupled to the nozzle 20. The orifice cavity 38 is designed to receive the orifice assembly 70. The second profiled surface 36 is located between the orifice cavity 38 and the second engagement surface 32. While in the first example in FIG. 2 the second profiled surface 36 may be a bevel, as shown in FIGS. 4-7, it may instead be approximately parallel to the inlet passage 24. Of course, other geometric shapes may be used for the second profiled surface 36 such as oval or elliptical shapes, so long as the second profiled surface allows the collimating chamber 80 to have an expanded diameter beyond the diameter of the inlet passage 24 and a gradual reduction in diameter to the orifice member 50. Of course, as illustrated in FIG. 3, the nozzle nut 30 may be formed without the second profiled surface 36 with the collimating chamber 80 being formed primarily from the expanded region 29 of the nozzle 20 with a small portion of the collimating chamber 80 being formed by the orifice assembly 70. The second profiled surface 36 meets the second sealing surface 32 at an inner nut edge 35. Therefore, the inner nut edge 35 meets the inner nozzle edge 29 to make a smooth transition between the nozzle 20 and nozzle nut 30 to prevent turbulence within the collimating chamber 80.

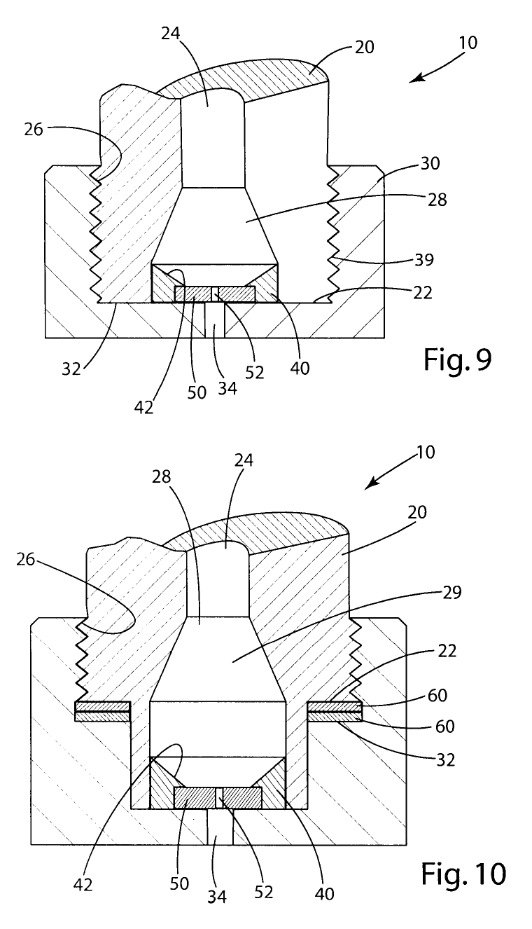

The orifice assembly 70 which fits within the orifice cavity 38 on the nozzle nut 30 includes an orifice member 50 and a retainer 40. The orifice member 50 is typically formed out of a hard material such as sapphire, ruby, or diamond and has an orifice passage 52 which restricts the flow of the high pressure water within the collimating chamber 80 to a very small outlet to create the high velocity water stream. The retainer 40 is formed from titanium, however alternate materials such as delrin, acetal, peek or other materials with similar properties may be used. The retainer 40 includes tabs or fingers 44 which hold the orifice member 50 in place. The tabs or fingers 44 create a spring-like effect to hold the orifice member 50 in place. While being illustrated as planar in FIG. 2, the orifice member 50 may have a chamber surface 51 that is not planer but is instead profiled to a beveled, oval, elliptical, or other shape. The retainer 40 includes an inner retainer surface 42 which has a geometric profile and forms part of the surface of the collimating chamber 80. The inner retainer surface 42 is illustrated in FIGS. 2-5 and 7-10 as being a beveled shape. Of course, as illustrated in FIG. 6, an elliptical shape, conical or other geometric shape may be used as the inner retainer surface 42. Generally, it has been found helpful to have the retainer 40 to slope with a reducing diameter from the second profiled surface 36 to the orifice member 50. More particularly, as the inner retainer surface 42 gets closer to the orifice, the retainer extends in thickness between the inner retainer surface 42 and the inside wall 71 of the nut 30 causing the diameter formed by a plane passing through the retainer 40 to be reduced. Therefore, when viewed in cross-section as illustrated in the figures, the retainer has a beveled surface and when viewed in whole or in perspective (not illustrated) it has a frusto-conical shape.

The inventors have found that a high velocity stream exiting through the orifice passage 52 may be improved to have tighter more cohesive stream characteristics and thereby provide improved cutting performance by having the water pass through an inlet passage 24 into a collimating chamber 80 wherein the collimating chamber 80 expands in diameter over the inlet passage 24. It is believed that the expanded diameter allows better flow movement before entering the orifice passage 52, which helps create the improved high velocity stream exiting the orifice passage. The expanded collimating chamber allows an area for the turbulence, which is believed to be primarily caused by the velocity of the water, to subside or calm as the water is being directed to the orifice passage. The reduction in turbulence is believed to result in an improved, more cohesive water stream exiting the orifice passage. Of course, the collimating chamber 80 is formed primary without sharp edges that may cause turbulence. The collimating chamber 80 may take on almost any shape so long as it expands in diameter. More specifically, it has been found that a smooth expansion in diameter from the inlet passage with a smooth reduction in diameter to the orifice member 50 is helpful in improving the stream characteristics of the exiting high velocity water stream. Therefore, the retainer 40 has been formed with a somewhat frusto-conical or in cross-section a beveled shape to help transition the reduction in diameter as the water approaches the orifice passage 52. The nozzle nut 30 may also facilitate this reduction in diameter. The collimating chamber 80 in the illustrated embodiment is defined by both the nozzle 20, the retainer, and typically at least a portion of the nozzle nut 30.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. An end assembly for a water cutting apparatus comprising:
a nozzle;
a nut coupled to said nozzle;
a collimating chamber defined between said nozzle and said nut, said collimating chamber having a volume and wherein a portion of said volume is formed by each of said nut and said nozzle.

2. The end assembly of claim 1 wherein said nozzle has a first profiled surface and said nut has a second profiled surface, said first and second profiled surfaces forming said collimating chamber.

3. The end assembly of claim 2 wherein said nozzle has a first engagement surface and said nut has a second engagement surface, said first engagement surface meeting said first profiled surface at an inner nozzle edge and said second engagement surface meeting said second profiled surface at an inner nut edge.

4. The end assembly of claim 3 wherein said inner nozzle edge and said inner nut edge having approximately the same diameter.

5. The end assembly of claim 2 wherein said first and second profiled surfaces are approximately mirror images of each other.

6. The end assembly of claim 1 wherein said nozzle has a first engagement surface and said nut has a second engagement surface, said first and second engagement surfaces engaging to form a water tight seal when said nut is coupled to said nozzle.

7. The end assembly of claim 1 wherein said nut further includes an orifice cavity for receiving an orifice assembly.

8. The end assembly of claim 7 further including a retainer securing an orifice member within said orifice cavity, said retainer being spaced a distance from said nozzle.

9. The end assembly of claim 8 wherein said retainer includes an inner retainer surface extending between said second profiled surface and said orifice member.

10. The end assembly of claim 9, wherein said inner retainer surface forms a frusto-conical shape.

11. The end assembly of claim 9 wherein said inner retainer surface has a first diameter near said second profiled surface and a second diameter near said orifice member and wherein said second diameter is smaller than said first diameter.

12. The end assembly of claim 9 wherein said inner retainer surface defines a portion of said collimating chamber.

13. The end assembly of claim 9 wherein said inner retainer surface is beveled.

14. The end assembly of claim 1 wherein said first profiled surface is beveled.

15. An end assembly for a water cutting apparatus comprising:
a nozzle having a first end and an opposing second end and an elongated passageway extending between said first and second ends and wherein said elongated passageway includes an expanded area portion;
a nut including an orifice assembly and wherein said nut and said orifice assembly define a collimating chamber in combination with said expanded area portion, said orifice assembly including a retainer and an orifice member and wherein said retainer includes an inner profiled surface extending from said nut to said orifice member with a decreasing diameter.

16. The end assembly of claim 15 wherein said inner retainer surface is frusto-conical shaped.

17. The end assembly of claim 16 wherein said nozzle includes a first profiled surface facing said inner retainer surface, said first profiled surface having a frusto-conical shape.

18. A nut having an orifice member for use with a water cutting apparatus, said nut comprising:
a cavity having a threaded area, a sealing surface, a profiled surface and orifice cavity, said sealing surface being located between said threaded area and said profiled surface; and
an orifice assembly retained within said orifice cavity, said orifice assembly including an orifice and a retainer having an inner retainer profile.

19. The nut of claim 18 wherein said orifice is formed from diamond.

20. The nut of claim 18 wherein said inner retainer surface has a frusto-conical shape.

21. The nut of claim 18 wherein said nut includes a portion of a collimating chamber defined between a plane forming the surface of the sealing surface, the profiled surface, and the orifice assembly.
